(19) United States
(12) Patent Application Publication
(10) Pub. No.: US 2006/0212859 A1
(43) Pub. Date: Sep. 21, 2006

(54) System and method for generating XML-based language parser and writer

(75) Inventors: Charles W. Parker, Sammamish, WA (US); Zhenguang Chen, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/084,763

(22) Filed: Mar. 18, 2005

(51) Int. Cl. G06F 9/45

(52) U.S. Cl. 717/143

(57) ABSTRACT

System and methods for generating an XML-based language parser and writer. Upon selection of a language, a parser-writer generator is arranged to receive language definition, a set of rules defining a structure of the language. The parser-writer generator generates code to be compiled into a parser and a writer. The parser takes input text adhering to the language schema and provides an AST reflecting the input text. The writer takes an AST that adheres to the language structure and provides output text in the selected language reflecting the AST.

### BACKGROUND OF THE INVENTION

A language parser is a software program, which takes as input a text stream that meets a particular language specification, and provides in response a parse tree or Abstract Syntax Tree (AST). The AST expresses a fundamental structure of the particular language and can be used to generate code in that language. A language writer is a complementary program that takes as input the AST and generates code in the chosen language.

A compiler-compiler or parser generator is a utility for generating the source code of a parser, interpreter or compiler from an annotated language description. Depending upon the type of parser that should be generated, these routines may construct a parse tree (or AST), or generate executable code directly.

Generally, language parsing tools such as YACC or Bison (YACC is a UNIX parser tool and Bison is a GNU implementation of YACC) leave the task of defining the AST to the person using the tool. The developer may build and maintain a set of data structures to represent the AST. In addition, changes to the language specification may result in changes to the grammar specification, to data structure definitions for the AST, and to the language rule processing code, which constructs the AST. This means that changes to the grammar definition for the language may cause changes in three separate areas of the code.

### SUMMARY OF THE INVENTION

Embodiments of the present invention relate to a system and method for generating an extensible Markup Language (XML)-based language parser and writer. XML documents are by definition tree structures, and XML Document Object Model (DOM) implementations provide a general purpose tree data structure. To eliminate the need for maintenance of a custom-built set of data structures for each particular language, XML is used to define the AST in one embodiment. An XML-based schema for describing the rules of a particular language is employed in a process for creating a recursive-descent parser from an XML document, which adheres to the XML-based schema of the language.

In accordance with one aspect of the present invention, a computer-implemented method for generating XML-based parser and writer is provided. The method includes receiving a language definition, generating a parser based on the language definition, receiving an input text that adheres to the language definition, and transforming the input text into an Abstract Syntax Tree (AST) employing the parser. The AST reflects the input text in compliance with the language definition.

The method may further include in a parsing mode, generating a function header upon finding a rule tag and generating an AST node for each token associated with the rule tag such that each node is based on a type of the token. In a writing mode, the method may include generating code upon finding a tag for an AST construct and generating a phrase that adheres to the language definition for each node within the AST construct such that the nodes are arranged in an XML-tree structure.

### BRIEF DESCRIPTION OF THE DRAWINGS

FIG. 1 illustrates a computing device that may be used according to an example embodiment.

FIG. 2 is a block diagram showing an operating environment of a parser-writer generator according to one embodiment.

FIG. 3 is a state diagram illustrating parallel parsing and writing processes employing a parser generator and a writer generator.

FIG. 4 is a logic flow diagram illustrating a process for parsing according to another embodiment.

FIG. 5 is a logic flow diagram illustrating a process for writing according to a further embodiment.

FIGS. 6A and 6B illustrate XML markups for two example rules.

FIGS. 7A and 7B illustrate the XML markups of FIGS. 6A and 6B amended with AST nodes such that an AST is constructed from the rules.

FIG. 8 illustrates an XML tree of an example sentence according to the AST constructed in FIGS. 6 and 7.

### DETAILED DESCRIPTION

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

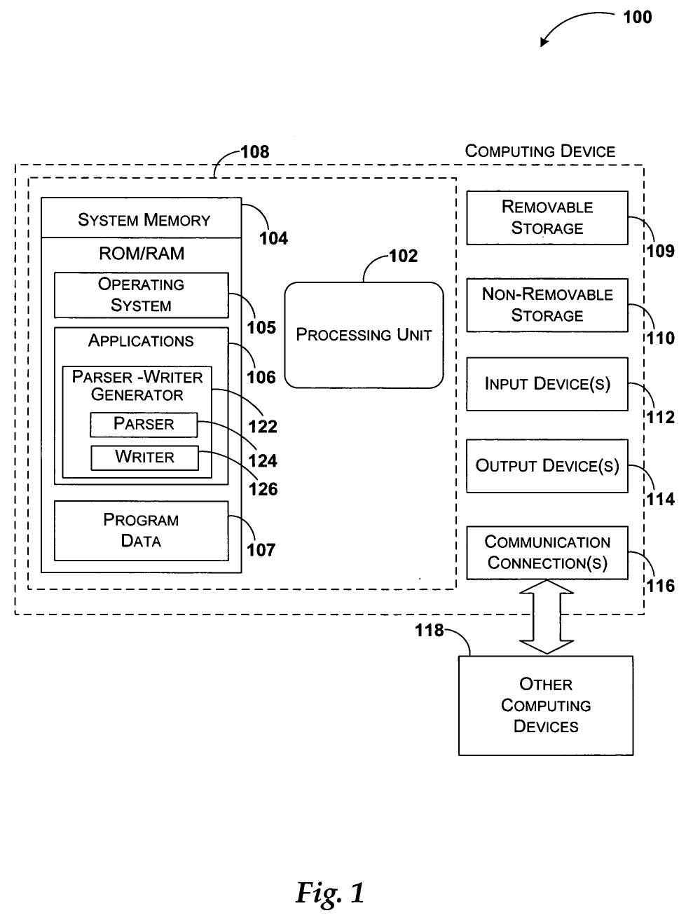

Referring to FIG. 1, an example system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes an operating system 105, one or more applications 106, and may include program data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. All these devices are known in the art and need not be discussed at length here.

Computing device 100 also contains communications connection(s) 116 that allow the device to communicate with other computing devices 118, such as over a network or a wireless mesh network. Communications connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one embodiment, applications 106 further include parser-writer generator 122. Parser-writer generator 122 is arranged to generate parser module 124 that takes text in a selected language as input and creates an AST for the language. In generating parser module 124, parser-writer generator 122 uses language definitions for the selected language. Parser-writer generator 122 is further arranged to generate writer module 126 that takes the AST as input and creates text in the selected language. The functionality represented by parser-writer generator 122 may be further supported by additional input devices, 112, output devices 114, and communication connection(s) 116 that are included in computing device 100 for generating parser module 124 and writer module 126.

Illustrative Embodiments For Generating XML-based Language Parser and Writer

Embodiments of the present invention are related to generating an XML-based parser and a writer. In one embodiment, a parser-writer generator, takes as input a language definition and adheres to a schema for defining languages, by means of specifying rules. The parser-writer generator produces as output ‘code’ for a language parser. The produced parser accepts as input text, and in the event that the input text adheres to the rules defined by the language definition, the parser will generate an XML Document Object Model (DOM) in accordance with the language definition used to produce the parser. The parser performs recursive decent parsing. Accordingly, the parser is defined by the rules of the language.

In another embodiment, the parser-writer generator takes as input the language definition and produces as output ‘code’ for a writer. The writer, given an XML DOM that adheres to the AST defined by the language definition, generates text in accordance with the language definition that is used to produce the writer.

Embodiments of the present invention may be applied to standards-based languages, non-standard languages, or modified standards-based languages (“dialects”). Because the parser and the writer are generated based on the rules of the particular language, the parser-writer generator is independent of any particular language.

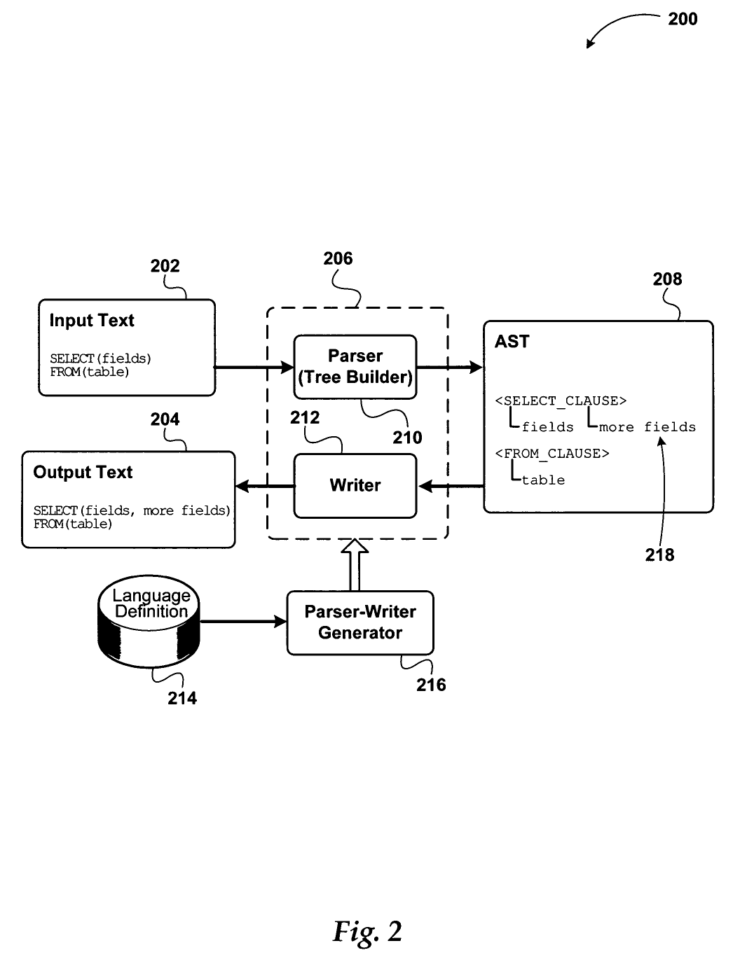

FIG. 2 includes block diagram 200 showing an operating environment of a parser-writer generator according to one embodiment. Block diagram 200 includes input text 202, output text 204, language processing modules 206, AST 208, language definition database 214, and parser-writer generator 216. Language processing modules 206 include writer 210 and parser (also called tree builder) 212.

Parser-writer generator 216 is arranged to receive a language definition document (LDD) from language definition database 214 for a particular language and generate writer 210 and parser 212 for that language. Parser 210 is arranged to receive input text 202 in the selected language and create AST 208 for the language. For example, input text may include command lines: SELECT (fields), FROM (table). Parser 212 may generate an AST that includes node <SELECT_CLAUSE> with child node fields and node <FROM_CLAUSE> with child node table. A developer may modify the AST to add child node more fields to node <SELECT_CLAUSE>.

Once the AST is constructed, writer 210 may receive AST 208 and create output text 204 in the selected language. In the above described example, output text 204 based on AST 208 is SELECT (fields, more fields), FROM (table).

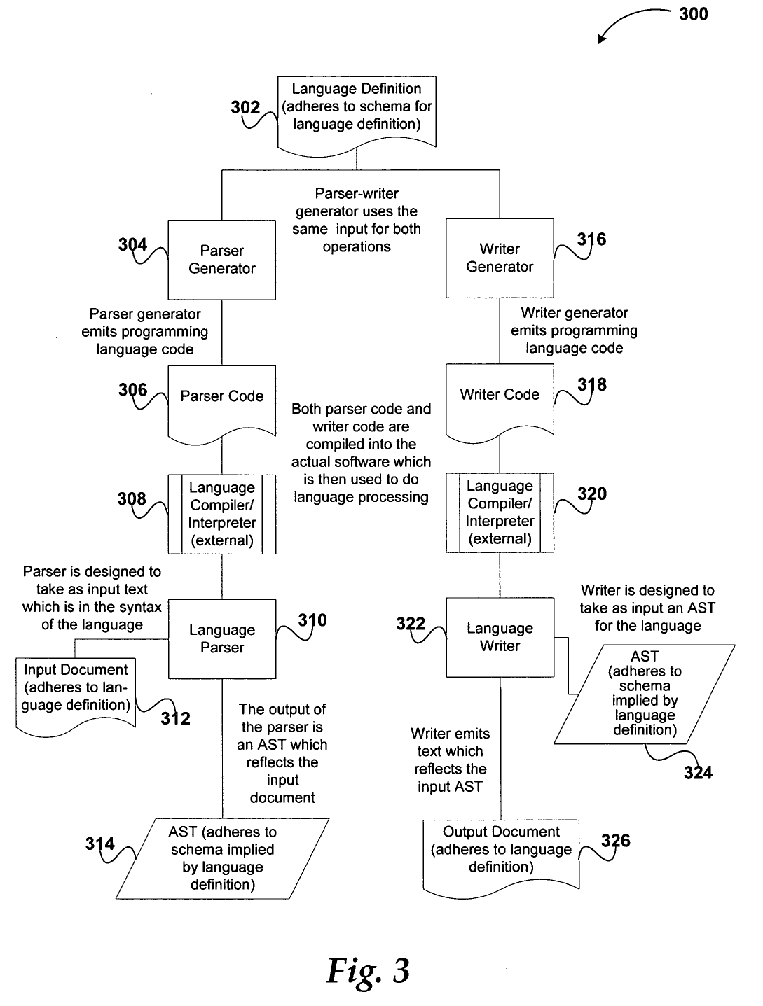

FIG. 3 includes state diagram 300 illustrating parallel parsing and writing processes employing a parser generator and a writer generator. State diagram 300 begins with language definition document 302. According to one embodiment, this document is an XML document, which adheres to a schema designed to describe common language rules and how they are processed into and out of an AST.

In one operation mode, parser-writer generator acts as parser generator 304 and creates parser code 306. In another operation mode parser-writer generator acts as writer generator 316 and creates writer code 318. Both codes are then compiled into software programs, which is used to process the language.

Language compiler/interpreter 308 may be used to compile parser code 306. Language compiler/interpreter 320 may be used to compile writer code 318. In one embodiment, both language compiler/interpreters 308 and 320 may be external compilers.

Language parser 310, compiled by language compiler/interpreter 308 is arranged to receive input text from input document 312, which adheres to language definition 302. Similarly, language writer 322, compiled by language compiler/interpreter 320 is arranged to receive an AST for the language that adheres to schema implied by language definition 302.

Based on the input from input document 312, language parser 310 provides AST 314 that reflects the input document and adheres to the schema implied by language definition 302.

In the writer operation, language writer 322 provides output document 326 that reflects AST 324 and adheres to the schema implied by language definition 302.

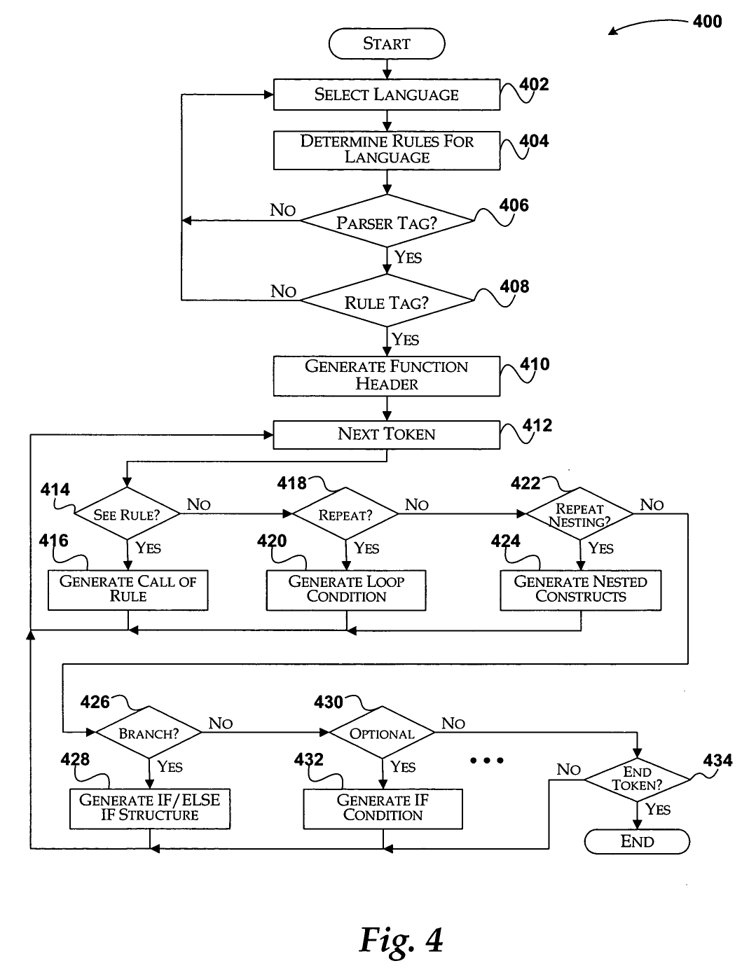

FIG. 4 is a logic flow diagram illustrating process 400 for parsing according to one embodiment. Process 400 may be performed by parser-writer generator 122 of FIG. 1 along with parser module 124. Process 400 begins at block 402, where a language to be parsed is selected. Processing moves to block 404 next.

At block 404, rules for the selected language are selected. In one embodiment, a number of default rule sets may be stored in a language rules database and retrieved based on the selection of the language at block 402. In another embodiment, the rules may be provided by a developer for the selected language. Processing proceeds from block 404 to decision block 406.

At decision block 406, a determination is made whether a parser tag is found in the input text. If the decision is that the parser tag is not found, processing returns to block 402. Otherwise, processing advances to decision block 408.

At decision block 408, a determination is made whether a rule tag is found in the input text. If the decision is that the rule tag is not found, processing again returns to block 402. If the rule tag is found, processing moves to block 410.

At block 410, a function header is generated. Parser module operates by checking the input text for tokens and determining which node is to be generated for the AST in response to each token. Processing then moves to block 412.

At block 412, a token is recognized. A number of tokens may vary depending on the complexity of the language that is being parsed. For illustration purposes, processes of parsing five different tokens are described here. Embodiments of the present invention may be implemented with fewer or additional tokens.

Processing moves from block 412 to decision block 414. As mentioned above, five different tokens are examined for illustration purposes. The first such token is a rule token. At decision block 414, a determination is made whether a rule is encountered. If a rule is not encountered, processing advances to decision block 418 to check if another token is found. Otherwise, processing moves to block 416.

At block 416 a call of the rule is generated (e.g. rulename: word) such that the rule can be called anywhere in the input text. From block 416, processing returns to block 412 to look for the next token.

At decision block 418, a determination is made whether a repeat token is encountered. If a repeat token is not encountered, processing advances to decision block 422 to check if another token is found. Otherwise, processing moves to block 420.

At block 420 a loop condition is generated based on the specific token (e.g. while (peek_token=“,”) generates a loop that continues as long as “,” is found). From block 420, processing returns to block 412 to look for the next token.

At decision block 422, a determination is made whether a repeat nesting token is encountered. If a repeat nesting token is not encountered, processing advances to decision block 426 to check if another token is found. Otherwise, processing moves to block 424.

At block 424 a number of nested constructs are generated based on the specific token (e.g. select(fields) from(table) where (graduation_year=“95” and major=“science” and age=“21”) generates a “where” construct within a “from” construct that is within a “select” construct. Furthermore, three additional “and” conditions are generated within the “where” construct. An AST for this example may look like following:

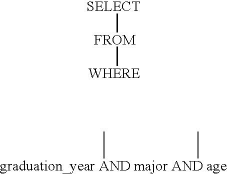

From block 420, processing returns to block 412 to look for the next token.

At decision block 426, a determination is made whether a branch token is encountered. If a branch token is not encountered, processing advances to decision block 430 to check if another token is found. Otherwise, processing moves to block 428.

At block 428 an “if/else if” structure is generated based on the specific path. For example, select (fields, functions) generates an “if” structure for fields path and another “if” structure for functions path. Within one branch structure any number of other branches may be generated. An end branch token may terminate the branch structures. From block 428, processing returns to block 412 to look for the next token.

At decision block 430, a determination is made whether an “optional” token is encountered. An “optional” token is configured to indicate an “if” condition based on various clauses. If the “optional” token is not encountered, processing advances to decision block 434 to check if an end token is found. Otherwise, processing moves to block 432.

At block 432 an “if” condition is generated based on the specific token(s). From block 432, processing returns to block 412 to look for the next token.

As mentioned before, combinations for decision and action blocks for other types of tokens may be employed in addition to the example block described above. After all checking for all types of tokens is completed, processing moves to decision block 434, where a determination is made whether an end token is found. If an end token is found at decision block 434, parsing process terminates. Otherwise, processing advances to block 412 for the next token.

Actions described here are for illustration purposes only. Embodiments may be implemented with fewer or additional blocks or other orders of the actions. For example, a “seetoken” tag may generate code which increments a current lexical token pointer. Tags designated as “other” may refer to any tag, which is not a parser schema tag. An “other” tag may result in generated code that adds a node to the AST tree as a child of the current node on the “stack”. Subsequently, the new node is pushed on the stack. At such time as a matching end tag is seen, code is generated to remove that node off the stack. This is one of the essential mechanisms by which the tree is constructed.

A process of writing text in a selected language essentially mirrors process 400 for parsing. Upon selection of a language and retrieval of language rules for the selected language, an AST is provided as input. A writer module looks for tags in the AST (XML tree) instead of tokens in process 400.

For each tag found an associated rule is applied with the provided value for the rule and text constructed accordingly. Similar to process 400, a number of tags may vary depending on the complexity of the language in which the output text is being written.

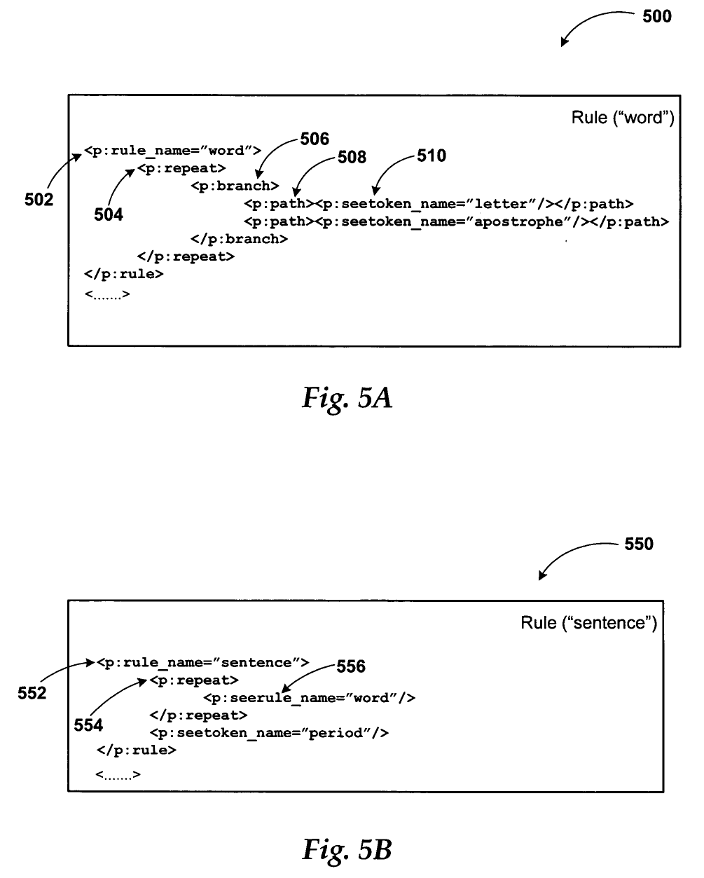

FIGS. 5A and 5B illustrate XML markups for two example rules. Example rules 500 and 550 are generated in a hypothetical language loosely based on English grammatical structure. Example rule 500 of FIG. 5A indicates that a word is any combination of letters and apostrophe's. Accordingly, XML markup for example rule 500 begins in line 502 with the call for the rule “word.” Next, line 504 begins a repeat loop. Line 506 begins a branch structure where the path is checked for tokens named “letter” and “apostrophe.” Within the branch structure all letters and apostrophes are found to form the “word.”

Example rule 550 of FIG. 5B is for “sentence.” Under a similar construction, a “sentence” is formed by a combination of words and a period. Accordingly, line 552 provides the call for this rule “sentence.” The XML markup for example rule 550 looks for the rule “word” (556) within repeat construct 554 to find all words for the “sentence.” Because the rule for “sentence” includes one period, the search for the token for period is outside the repeat construct.

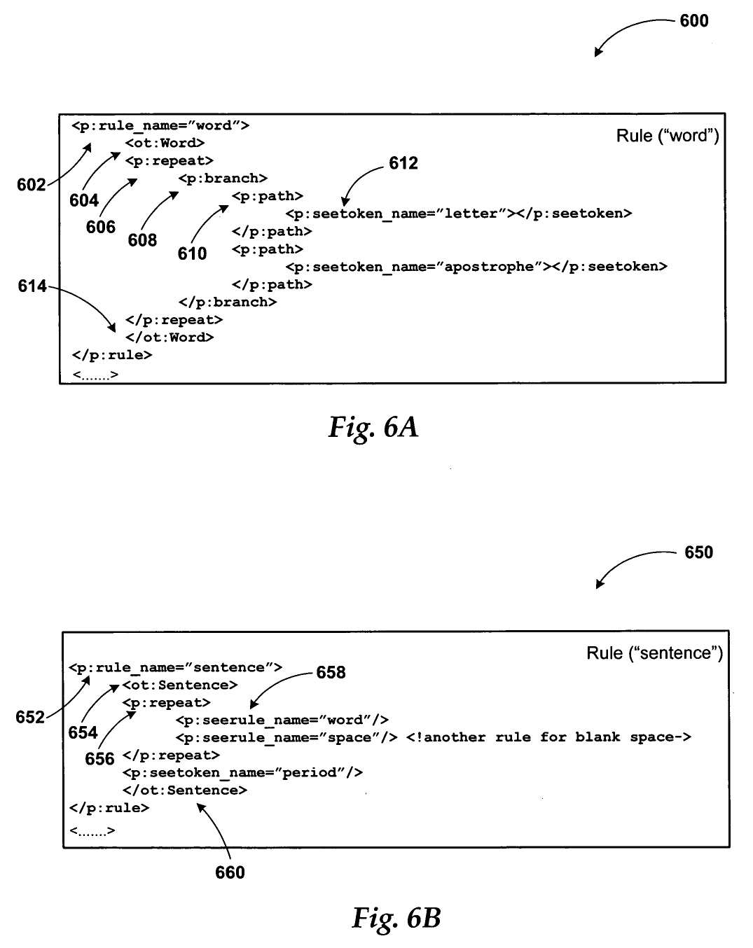

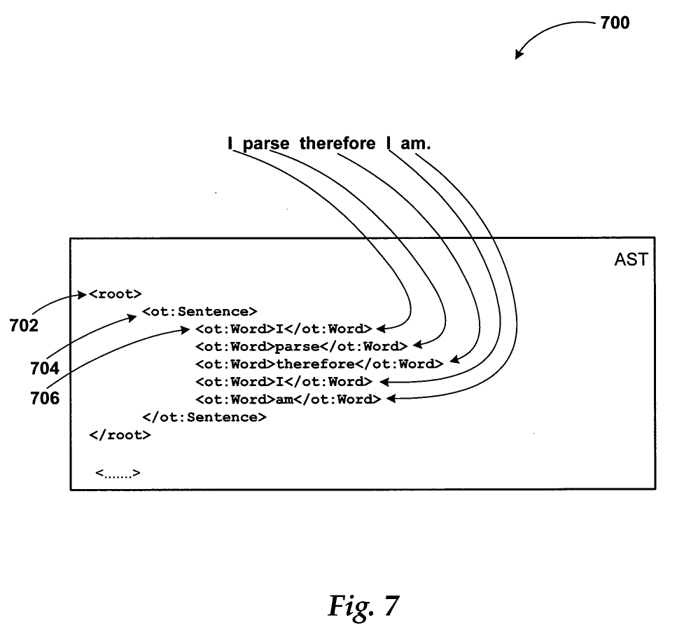

FIGS. 6A and 6B illustrate XML markups 600 and 650 of the XML markups of FIGS. 7A and 7B amended with AST nodes such that an AST is constructed from the rules. To build an AST from the markups, AST nodes are interspersed in the markups for the rules.

Example rule 600 for “word” includes rule_name 602, repeat construct 606, branch construct 608 and path construct 610 for searching the path for tokens such as letter (612) or apostrophe. Additionally, AST nodes 604 and 614 (<ot: Word> and </ot: Word>) are placed immediately after the call for the rule and before the rule ends. This indicates to the parser that a new section named “Word” is to be added to the AST for the hypothetical language.

Similarly, example rule 650 for “sentence” includes AST nodes 654 and 660 (<ot:Sentence>and </ot:Sentence>) indicating beginning and end for the new AST section for “Sentence.”

FIG. 7 illustrates XML tree 700 of an example sentence according to the AST constructed in FIGS. 6A and 6B. XML tree 700 (AST) is parsed from example sentence: “I parse therefore I am.”

XML tree 700 begins with begin-root tag (root) 702 indicating a root for the AST. Next line begins AST node 704 for “Sentence”. Under AST node 704, each word of the example sentence is represented as a child node (e.g. child node 706). Child nodes begin with the begin-node tag (ot) and the rule for the node (Word), include the value to be used with the rule in the child node, and end with end-node tag (/ot). The end of child nodes is indicated with end-node tag for parent node (Sentence). XML tree 800 is terminated with end-root tag (/root).

Example XML markups shown in FIGS. 5A, 5B, 6A, and 6B are provided for illustration purposes only. The invention is not limited to these examples. Various embodiments of the present invention may be implemented in other ways.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for parsing a computer language, comprising:
receiving a language definition;
generating a parser based on the language definition;
receiving input text, wherein the input text adheres to the language definition; and
transforming the input text into an Abstract Syntax Tree (AST) employing the parser, wherein the AST reflects the input text in compliance with the language definition.

2. The method of claim 1, wherein receiving the language definition comprises:
selecting a language; and
receiving a set of rules that define the language.

3. The method of claim 1, wherein generating the parser comprises:
generating code for the parser; and
compiling the code such that the parser is employed to transform the input text.

4. The method of claim 2, wherein the language is an XML-based language, and the AST is an XML tree.

5. The method of claim 1, wherein transforming the input text into the AST comprises:
generating a function header in response to finding a rule tag; and
generating an AST node for each token associated with the rule tag, wherein each node is based on a type of the token.

6. The method of claim 5, wherein the type of the token includes at least one of a repeat token, a repeat nesting token, a branch token, a seetoken token, an optional token, and an “other” token.

7. The method of claim 5, wherein generating the AST nodes is terminated in response to finding an end token.

8. The method of claim 1, further comprising generating source code for a lexical analyzer based on the language definition.

9. A computer-implemented method for writing an output text in a selected computer language, comprising:
receiving a language definition associated with the selected language;
generating a writer based on the language definition;
receiving an AST, wherein the AST adheres to the language definition; and
transforming the AST into the output text employing the writer, wherein the output text reflects the AST in compliance with the language definition.

10. The method of claim 9, wherein the language definition includes a set of rules associated with the selected language, and wherein the set of rules is received from at least one of a database and a user input.

11. The method of claim 9, wherein generating the writer comprises:
generating code for the writer; and
compiling the code such that the writer is employed to transform the AST.

12. The method of claim 9, wherein transforming the AST into the output text comprises:
generating code in response to finding a tag for an AST construct; and
generating a phrase that adheres to the language definition for each node within the AST construct, wherein the nodes are arranged in an XML-tree structure.

13. The method of claim 12, wherein generating the phrases is terminated in response to finding an end tag.

14. A computer-readable medium having computer instructions for parsing and writing a computer language, the instructions comprising:
selecting the computer language;
receiving a language definition;
generating a parser and a writer based on the language definition;
selectively transforming an input text into an AST employing the parser, wherein the AST reflects the input text in compliance with the language definition; and
selectively transforming the AST into an output text employing the writer, wherein the output text reflects the AST in compliance with the language definition.

15. The computer-readable medium of claim 14, wherein the language definition includes a set of rules associated with the selected language, and wherein the set of rules is received from at least one of a database and a user input.

16. The computer-readable medium of claim 14, wherein generating the parser and the writer comprises:
generating source code for the parser such that the source code includes code corresponding to rules of the language definition and code that maintains a number of tokens specified by each rule within the input text; and
generating source code for the writer such that the source code includes code corresponding to rules of the language definition and code that maintains a number of nodes specified by each tag within the AST.

17. The computer-readable medium of claim 16, wherein generating the parser and the writer further comprises compiling the source code for the parser such that the parser is operated as a recursive decent parser.

18. The computer-readable medium of claim 14, wherein generating the parser and the writer is performed using an XML-based language.

19. The computer-readable medium of claim 14, wherein transforming the input text into an AST comprises:
generating a function header in response to finding a rule tag; and
generating an AST node for each token associated with the rule tag, wherein each node is based on a type of the token.

20. The computer-readable medium of claim 14, wherein transforming the AST into the output text comprises:
generating code in response to finding a tag for an AST construct; and
generating a phrase that adheres to the language definition for each node within the AST construct, wherein the nodes are arranged in an XML-tree structure.
